(19) United States
(12) Patent Application Publication
(10) Pub. No.: US 2019/0075607 A1
(43) Pub. Date: Mar. 7, 2019

(54) METHOD AND APPARATUS FOR PROVIDING WFD SERVICE ON BASIS OF 60GHz FREQUENCY IN WIRELESS COMMUNICATION SYSTEM

(71) Applicant: LG ELECTRONICS INC., Seoul (KR)

(72) Inventors: Giwon Park, Seoul (KR); Jinmin Kim, Seoul (KR); Byungjoo Lee, Seoul (KR)

(21) Appl. No.: 15/898,349

(22) Filed: Feb. 16, 2018

Related U.S. Application Data
(60) Provisional application No. 62/554,545, filed on Sep. 5, 2017.

(51) Int. Cl. H04W 76/14; H04W 92/18; H04W 8/24; H04W 16/14

(52) U.S. Cl. CPC H04W 76/14; H04W 92/18; H04W 88/06; H04W 16/14; H04W 8/24

(57) ABSTRACT

A method for performing 60 GHz WFD (Wi-Fi Display) connection by a first terminal in a wireless communication system is disclosed. The method includes transmitting, by the first terminal, a message requesting 60 GHz WFD connection to a second terminal through an access point (AP); and receiving a message accepting 60 GHz WFD connection from the second terminal through the access point (AP). The 60 GHz WFD connection request message includes capability information indicating whether the first terminal supports 60 GHz. The 60 GHz WFD connection accept message includes capability information indicating whether the second terminal supports operation at 60 GHz. The messages are exchanged with each other on the basis of at least one of 2.4 GHz and 5 GHz.

This application claims the benefit of U.S. Provisional Application No. 62/554,545, filed on Sep. 5, 2017, which is hereby incorporated by reference as if fully set forth herein.

### BACKGROUND OF THE INVENTION

### Field of the Invention

The present invention relates to a wireless communication system, and more particularly to a method and apparatus for providing a Wi-Fi Display (WFD) service on the basis of a frequency of 60 GHz in a wireless communication system.

### Discussion of the Related Art

Wireless access systems have been widely deployed to provide various types of communication services such as voice or data. In general, a wireless access system is a multiple access system that may support communication of multiple users by sharing available system resources (e.g., a bandwidth, transmission power, etc.). For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a multi carrier frequency division multiple access (MC-FDMA) system.

Recently, various wireless communication technologies have been developed with the advancement of information communication technology. Among the wireless communication technologies, a wireless local area network (WLAN) is the technology capable of accessing the Internet by wireless in a home, a company or a specific service provided area through portable device such as a personal digital assistant (PDA), a laptop computer, a portable multimedia player (PMP), etc. based on a radio frequency technology.

A standard for a WLAN (wireless local area network) technology is developing by IEEE (institute of electrical and electronics engineers) 802.11 group. IEEE 802.11a and b use an unlicensed band on 2.4 GHz or 5 GHz, IEEE 802.11b provides transmission speed of 11 Mbps and IEEE 802.11a provides transmission speed of 54 Mbps. IEEE 802.11g provides transmission speed of 54 Mbps by applying OFDM (orthogonal frequency division multiplexing) on 2.4 GHz. IEEE 802.11n provides transmission speed of 300 Mbps by applying MIMO-OFDM (multiple input multiple output-orthogonal frequency division multiplexing). IEEE 802.11n supports a channel bandwidth up to 40 MHz. In this case, transmission speed can be provided as fast as 600 Mbps. IEEE 802.11p corresponds to a standard for supporting WAVE (wireless access in vehicular environments). For instance, 802.11p provides improvement necessary for supporting ITS (intelligent transportation systems). IEEE 802.11ai corresponds to a standard for supporting fast initial link setup of IEEE 802.11 station.

A DLS (direct link setup)-related protocol in wireless LAN environment according to IEEE 802.11e is used on the premise of a QBSS (quality BSS) supporting QoS (quality of service) supported by a BSS (basic service set). In the QBSS, not only a non-AP STA but also an AP corresponds to a QAP (quality AP) supporting QoS. Yet, in current commercialized wireless LAN environment (e.g., wireless LAN environment according to IEEE 802.11a/b/g etc.), although a non-AP STA corresponds to a QSTA (quality STA) supporting QoS, most of APs corresponds to a legacy AP incapable of supporting QoS. Consequently, in the current commercialized wireless LAN environment, there is a limit in that a QSTA is unable to use a DLS service.

In a recent situation that such a wireless short-range communication technology as Wi-Fi and the like is widely applied to a market, connection between devices is performed not only based on a local network but also based on direct connection between devices. One of technologies enabling devices to be directly connected is Wi-Fi Direct.

Wi-Fi Direct corresponds to a network connectivity standard technology describing up to operations of a link layer. Since there is no definition on a regulation or a standard for an application of a higher layer, it is difficult to have compatibility and consistency of an operation after Wi-Fi Direct devices are connected with each other. For this reason, such a standard technology including higher layer application technology as WFDS (Wi-Fi Direct service) is under discussion by WFA (Wi-Fi alliance).

The WFA has announced such a new standard for delivering data via a direct connection between mobile devices as Wi-Fi Direct. Hence, related industries are actively developing a technology for satisfying the Wi-Fi Direct standard. In a strict sense, the Wi-Fi Direct is a marketing terminology and corresponds to a brand name. A technology standard for the Wi-Fi Direct is commonly called Wi-Fi P2P (peer to peer). Hence, the present invention describing Wi-Fi-based P2P technology may be able to use Wi-Fi Direct and Wi-Fi P2P without any distinction. In a legacy Wi-Fi network, a user accesses the legacy Wi-Fi network via an AP (access point) and accesses the Internet to use a device on which Wi-Fi is mounted. A data communication method via direct connection between devices is also used in a legacy communication by some users in a manner of being mounted on a device (e.g., a cellular phone, a note PC, etc.) on which a wireless communication technology such as Bluetooth is mounted. Yet, according to the data communication method, transmission speed is slow and transmission distance is limited to within 10 m. In particular, when the data communication method is used for transmitting massive data or is used in environment at which many Bluetooth devices exist, there exists a technical limit in performance capable of being felt by a user.

Meanwhile, Wi-Fi P2P maintains most of functions of the legacy Wi-Fi standard and includes an additional part for supporting direct communication between devices. Hence, the Wi-Fi P2P can sufficiently utilize hardware and physical characteristics of a device on which a Wi-Fi chip is mounted and is able to provide device-to-device P2P communication by upgrading a software function only.

As widely known, the device on which the Wi-Fi chip is mounted is extending to various ranges including a note PC, a smartphone, a smart TV, a game console, a camera and the like. For the device, sufficient numbers of suppliers and technology development personnel have been formed.

In recent times, standards of a method for using a 60 GHz band in a wireless LAN (WLAN) environment based on IEEE 802.11ay have been defined.

### SUMMARY OF THE INVENTION

Accordingly, the present invention is directed to a method for providing a Wi-Fi Display (WFD) service on the basis of a frequency of 60 GHz in a wireless communication system.

An object of the present invention is to provide a method for providing a WFD service based on a frequency of 60 GHz in a wireless communication system.

Another object of the present invention is to provide a method for performing WFD connection in consideration of 60 GHz frequency characteristics in a wireless communication system.

Another object of the present invention is to provide a method for providing WFD connection at 60 GHz using 2.4 GHz or 5 GHz in a wireless communication system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for performing 60 GHz WFD (Wi-Fi Display) connection by a first terminal in a wireless communication system, comprising: transmitting, by the first terminal, a message requesting the 60 GHz WFD connection to a second terminal through an access point (AP); and receiving a message accepting the 60 GHz WFD connection from the second terminal through the access point (AP), wherein the 60 GHz WFD connection request message includes capability information indicating whether the first terminal supports 60 GHz, the 60 GHz WFD connection accept message includes capability information indicating whether the second terminal supports 60 GHz, and the messages are exchanged with each other on the basis of at least one of 2.4 GHz and 5 GHz.

In accordance with another aspect of the present invention, A first terminal for performing 60 GHz WFD (Wi-Fi Display) connection in a wireless communication system, comprising: a receiver configured to receive information from an external device; a transmitter configured to transmit information to the external device; and a processor configured to control the receiver and the transmitter, wherein the processor transmits a message requesting the 60 GHz WFD connection to a second terminal through an access point (AP) using the transmitter, receives a message accepting the 60 GHz WFD connection from the second terminal through the access point (AP) using the receiver, wherein the 60 GHz WFD connection request message includes capability information indicating whether the first terminal supports 60 GHz, the 60 GHz WFD connection accept message includes capability information indicating whether the second terminal supports 60 GHz, and the messages are exchanged with each other on the basis of at least one of 2.4 GHz and 5 GHz.

The method further comprising: transmitting, by the first terminal, the message confirming the 60 GHz WFD connection to the second terminal through the access point (AP).

The message requesting the 6 GHz WFD connection may include best sector ID (identifier) information, and designates a sector by which the second terminal performs packet transmission on the basis the best sector ID information.

the second terminal may transmit information about a best sector of the second terminal to the access point (AP) on the basis of a sector level sweep (SLS) phase performed not only by the second terminal but also by the access point (AP), and the first terminal may receive the second terminal's best sector information transmitted from the second terminal to the access point (AP).

The best sector information of the second terminal may indicate a sector having the highest SNR (Signal to Noise Ratio) or the highest RSSI (Received Signal Strength Indicator) from among a plurality of sectors established by the second terminal at 60 GHz.

The message accepting the 6 GHz WFD connection may include best sector ID (identifier) information, and designates a sector by which the first terminal performs packet transmission on the basis the best sector ID information.

The message confirming the 6 GHz WFD connection may include best sector ID (identifier) information, and designates not only a sector by which the first terminal performs packet transmission, but also a sector by which the second terminal performs packet transmission based on the best sector ID information.

When the first terminal and the second terminal directly perform the 60 GHz WFD connection at 60 GHz, the first terminal may exchange best sector ID information with the second terminal on the basis of a Sector Level Sweep (SLS) phase.

The first terminal may be a WFD source terminal, and the second terminal may be a WFD sink terminal.

when packet transmission is performed at 2.4 GHz or 5 GHz, the packet may be transmitted omnidirectionally; and when packet transmission is performed at 60 GHz, the packet may be transmitted in a specific direction.

The processor may transmit the message confirming the 60 GHz WFD connection to the second terminal through the access point (AP) using the transmitter.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a structure of an IEEE 802.11 system to which the present invention can be applied.

FIG. 2 is a block diagram illustrating an exemplary operation of a communication system employing access devices and wireless devices.

FIG. 3 illustrates a Wi-Fi Direct (WFD) network.

FIG. 4 illustrates a process of constructing a WFD network

FIG. 5 illustrates a typical P2P network topology.

FIG. 6 illustrates a situation in which one P2P device forms a P2P group and, simultaneously, operates as an STA of a WLAN to be connected to an AP.

FIG. 7 illustrates a WFD network state when P2P is applied thereto.

FIG. 8 is a schematic block diagram of a Wi-Fi Direct Services (WFDS) device.

FIG. 9 illustrates a process of performing device discovery and service discovery between WFDS devices to connect a WFDS session in conventional WFDS.

FIG. 10 illustrates a service application platform supporting multiple interfaces.

FIG. 11 is a structural view illustrating a data and control plane for use in a WFD terminal.

FIG. 12 is a conceptual diagram illustrating a method for performing Sector Level Sweep (SLS).

FIG. 13 is a conceptual diagram illustrating a method for exchanging a Tunneled Direct Link Setup (TDLS) message.

FIG. 14 is a conceptual diagram illustrating a method for establishing WFD connection by WFD terminals.

FIG. 15 is a conceptual diagram illustrating a method for establishing sectors by WFD terminals.

FIG. 16 is a conceptual diagram illustrating a method for exchanging beamforming control information.

FIG. 17 is a flowchart illustrating a method for performing WFD connection.

FIG. 18 is a block diagram illustrating a terminal device according to an embodiment of the present invention.

### DESCRIPTION OF SPECIFIC EMBODIMENTS

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide the full understanding of the present invention. However, it will be apparent to those skilled in the art that the present invention may be implemented without such specific details.

The following embodiments can be achieved by combinations of structural elements and features of the present invention in prescribed forms. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

Specific terminologies in the following description are provided to help the understanding of the present invention. And, these specific terminologies may be changed to other formats within the technical scope or spirit of the present invention.

Occasionally, to avoid obscuring the concept of the present invention, structures and/or devices known to the public may be skipped or represented as block diagrams centering on the core functions of the structures and/or devices. In addition, the same reference numbers will be used throughout the drawings to refer to the same or like parts in this specification.

The embodiments of the present invention can be supported by the disclosed standard documents disclosed for at least one of wireless access systems including IEEE 802 system, 3GPP system, 3GPP LTE system, LTE-A (LTE-Advanced) system and 3GPP2 system. In particular, the steps or parts, which are not explained to clearly reveal the technical idea of the present invention, in the embodiments of the present invention may be supported by the above documents. Moreover, all terminologies disclosed in this document can be supported by the above standard documents.

The following embodiments of the present invention can be applied to a variety of wireless access technologies, for example, CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc.

Although the terms such as “first” and/or “second” in this specification may be used to describe various elements, it is to be understood that the elements are not limited by such terms. The terms may be used to identify one element from another element. For example, a first element may be referred to as a second element, and vice versa within the range that does not depart from the scope of the present invention.

In the specification, when a part “comprises” or “includes” an element, it means that the part further comprises or includes another element unless otherwise mentioned. Also, the terms “. .unit”, “ . . . module” disclosed in the specification means a unit for processing at least one function or operation, and may be implemented by hardware, software or combination of hardware and software.

For clarity, the following description focuses on IEEE 802.11 systems. However, technical features of the present invention are not limited thereto.

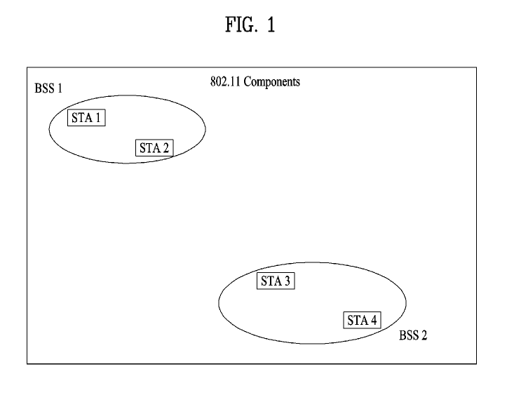

FIG. 1 is a diagram for an example of a structure of IEEE 802.11 system to which the present invention is applicable.

IEEE 802.11 structure can consist of a plurality of configuration elements and a WLAN supporting mobility of an STA, which is transparent to an upper layer, can be provided by interaction of a plurality of the configuration elements. A basic service set (hereinafter abbreviated BSS) may correspond to a basic configuration block in IEEE 802.11 LAN. FIG. 1 shows an example that there exist two BSSs (BSS 1 and BSS 2) and two STAs are included in each of the BSSs as members, respectively (STA 1 and STA 2 are included in the BSS 1 and STA 3 and STA 4 are included in the BSS 2). In this case, an STA indicates a device operating according to MAC (medium access control)/PHY (physical) standard of IEEE 802.11. An STA includes an AP (access point) STA (simply, an AP) and a non-AP STA. An AP corresponds to a device providing network access (e.g., WLAN) to a non-AP STA via a wireless interface. The AP can be configured by a fixed form or a mobile form and includes a mobile wireless device (e.g., a laptop computer, a smartphone, etc.) providing a hot-spot. The AP corresponds to a base station (BS), a Node-B, an evolved Node-B (eNB), a base transceiver system (BTS), a femto BS and the like in a different wireless communication field. The non-AP STA corresponds to a device directly controlled by a user such as a laptop computer, a PDA, a wireless modem, a smartphone and the like. The non-AP STA can be called a device, a wireless transmit/receive unit (WTRU), a user equipment (UE), a mobile station (MS), a mobile device, a mobile subscriber station (MSS), and the like.

An oval indicating a BSS in FIG. 1 may be comprehended as a coverage area of the STAs included in the BSS to maintain a communication. This area can be called a basic service area (hereinafter abbreviated BSA). A BSS of a most basic type in IEEE 802.11 LAN may correspond to an independent BSS (hereinafter abbreviated IBSS). For instance, the IBSS may have a minimum form consisting of two STAs only. The BSS (BSS 1 or BSS 2), which is the simplest form and omitted different configuration elements, in FIG. 1 may correspond to a representative example of the IBSS. This sort of configuration is available when the STAs are able to directly communicate with each other. And, this kind of LAN can be configured when a LAN is necessary instead of being configured in advance. Hence, this network may be called an ad-hoc network.

When power of an STA is turned on or turned off or an STA enters into a BSS area or gets out of the BSS area, a membership of the STA in a BSS can be dynamically changed. In order to be a member of the BSS, the STA can join the BSS using a synchronization process. In order to access all services based on a BSS structure, the STA can be associated with the BSS.

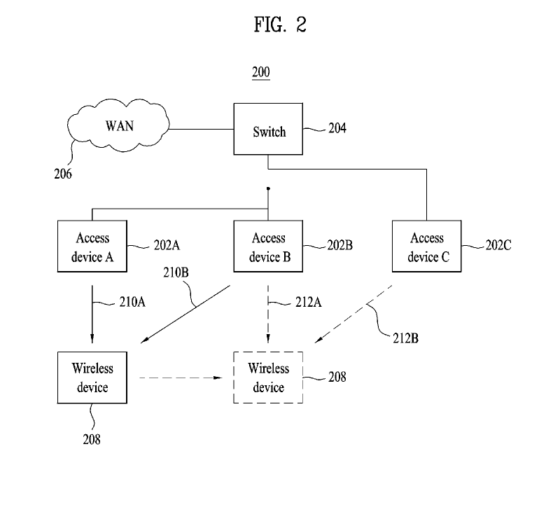

FIG. 2 is a block diagram for an example of a communication system 200 adopting access devices (e.g., AP STAs) 220A/202B/202C and wireless user devices (e.g., non-AP STAs).

Referring to FIG. 2, access devices 202A to 202C are connected with a switch 204 providing access to a WAN (wide area network) 206 such as the Internet. Each of the access devices 202A to 202C provides wireless access to wireless devices belonging to a coverage area (not depicted) of the access device via a time division multiplexed network. Hence, the access devices 202A to 202C commonly provide a total WLAN coverage area of the system 200. For instance, a wireless device 208 may exist in a coverage area of the access devices 202A and 202B in a position represented by a box of a line. Hence, the wireless device 208 can receive beacons from each of the access devices 202A/202B as shown by line arrows 210A and 210B. If the wireless device 208 roams to a dotted line box from the line box, the wireless device 208 enters a coverage area of the access device 202C and leaves a coverage area of the access device 202A. Hence, as shown by dotted lines 212A and 212B, the wireless device 208 can receive beacons from the access devices 202B/202C.

When the wireless device 208 roams in the total WLAN coverage area provided by the system 200, the wireless device 208 can determine which device provides best access to the wireless device 208. For instance, the wireless device 208 repeatedly scans beacons of adjacent access devices and may be able to measure signal strength (e.g., power) related to each of the beacons. Hence, the wireless device 208 can be connected with an access device providing optimal network access based on maximum beacon signal strength. The wireless device 208 may be able to use a different reference related to optimal access. For instance, the optimal access may be associated with more preferable services (e.g., contents, data rate and the like).

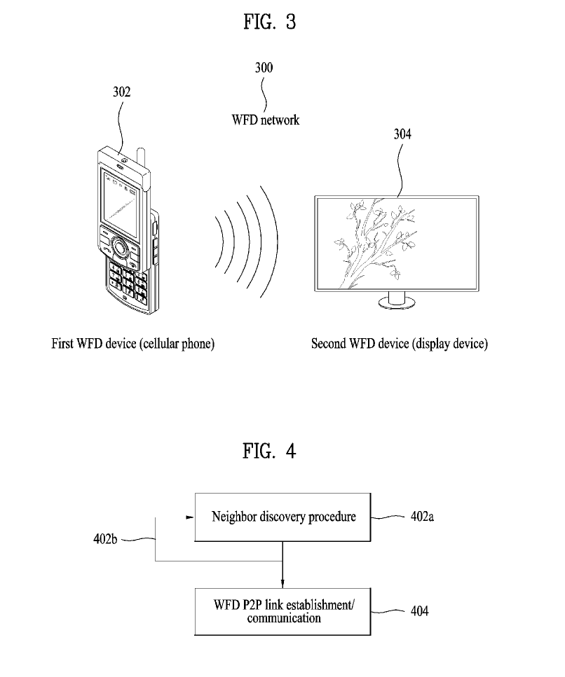

FIG. 3 is a diagram for an example of a WFD (Wi-Fi Direct) network.

A WFD network corresponds to a network capable of performing D2D (device-to-device) (or peer to peer (P2P) communication although Wi-Fi devices do not participate in a home network, an office network or a hot-spot network. The WFD network is proposed by Wi-Fi alliance. In the following, WFD-based communication is called WFD D2D communication (simply, D2D communication) or WFD P2P communication (simply, P2P communication). And, a device performing the WFD P2P communication is called a WFD P2P device, simply, a P2P device.

Referring to FIG. 3, a WFD network 300 can include at least one or more Wi-Fi devices including a first WFD device 302 and a second WFD device 304. A WFD device includes devices supporting Wi-Fi such as a display device, a printer, a digital camera, a projector, a smartphone and the like. And, the WFD device includes a non-AP STA and an AP STA. Referring to an example shown in the drawing, the first WFD device 302 corresponds to a smartphone and the second WFD device 304 corresponds to a display device. WFD devices in the WFD network can be directly connected with each other. Specifically, P2P communication may correspond to a case that a signal transmission path between two WFD devices is directly configured between the WFD devices without passing through a third device (e.g., an AP) or a legacy network (e.g., access WLAN via an AP). In this case, the signal transmission path directly configured between the two WFD devices may be restricted to a data transmission path. For instance, P2P communication may correspond to a case that a plurality of non-STAs transmit data (e.g., audio/image/text message information etc.) without passing through an AP. A signal transmission path for control information (e.g., resource allocation information for P2P configuration, wireless device identification information and the like) can be directly configured between WFD devices (e.g., between a non-AP STA and a non-AP STA, between a non-AP STA and an AP), between two WFD devices (e.g., between a non-AP STA and a non-AP STA) via an AP or between an AP and a corresponding WFD device (e.g., an AP and a non-AP STA #1, between an AP and a non-AP STA #2).

FIG. 4 is a flowchart for an example of a procedure of configuring a WFD network.

Referring to FIG. 4, a procedure of configuring a WFD network can be mainly divided into two procedures. A first procedure corresponds to a neighbor (device) discovery (ND) procedure [S402a] and a second procedure corresponds to a P2P link configuration and communication procedure [S404]. A WFD device (e.g., 302 in FIG. 3) finds out a different neighboring device (e.g., 304 in FIG. 3) in coverage (of the WFD device) via the neighbor discovery procedure and may be able to obtain information necessary for associating with the neighboring WFD device, e.g., information necessary for pre-association. In this case, the pre-association may indicate second layer pre-association in a wireless protocol. The information necessary for the pre-association can include identification information on the neighboring WFD device for example. The neighbor discovery procedure can be performed according to an available radio channel [S402b]. Subsequently, the WFD device 302 can perform a WFD P2P link configuration/communication procedure with the different WFD device 304. For instance, the WFD device 302 can determine whether the WFD device 304 corresponds to a WFD device not satisfying a service requirement of a user after the WFD device 302 is connected with the neighboring WFD device 304. To this end, the WFD device 302 is second layer pre-associated with the neighboring WFD device 304 and may be then able to search for the WFD device 304. If the WFD device 304 does not satisfy the service requirement of the user, the WFD device 302 disconnects the second layer connection established with the WFD device 304 and may be able to establish the second layer connection with a different WFD device. On the contrary, if the WFD device 304 satisfies the service requirement of the user, the two WFD devices 302/304 can transceive a signal with each other via a P2P link.

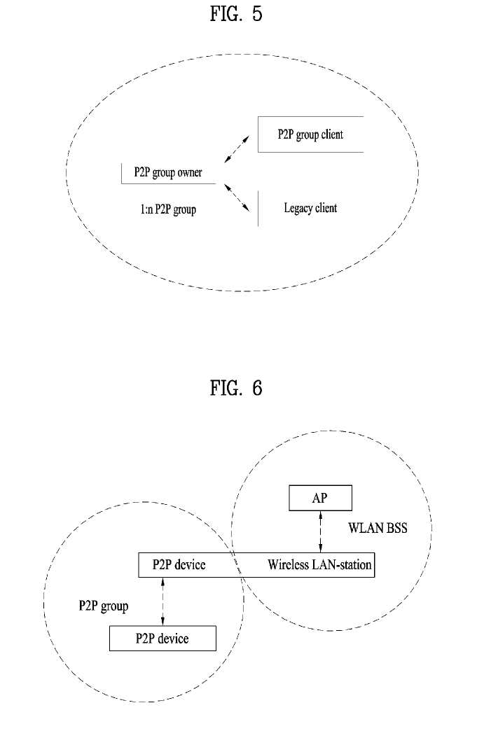

FIG. 5 is a diagram for a typical P2P network topology.

As shown in FIG. 5, a P2P GO can be directly connected with a client including a P2P function. Or, the P2P GO can be connected with a legacy client, which has no P2P function.

FIG. 6 is a diagram for a situation that a single P2P device forms a P2P group and is connected with an AP in a manner of operating as an STA of WLAN at the same time.

As shown in FIG. 6, according to P2P technical standard, a situation that a P2P device operates in the aforementioned mode is defined as a concurrent operation.

In order for a series of P2P devices to form a group, a P2P GO is determined based on a group owner intent value of a P2P attribute ID. The group owner intent value may have a value ranging from 0 to 15. P2P devices are exchanging the values and a P2P device including a highest value becomes the P2P GO. Meanwhile, in case of a legacy device not supporting the Wi-Fi P2P technology, although the legacy device can belong to a P2P group, a function of the legacy device is limited to a function of accessing an infrastructure network via the P2P GO.

According to Wi-Fi P2P standard, since a P2P GO transmits a beacon signal using OFDM (orthogonal frequency division multiplexing), a P2P device does not support 11b standard. Instead, 11a/g/n can be used as Wi-Fi P2P device.

In order to perform an operation of connecting a P2P GO and a P2P client with each other, a P2P standard mainly includes 4 functions described in the following.

First of all, P2P discovery is dealing with such a description entry as device discovery, service discovery, group formation and P2P invitation. According to the device discovery, 2 P2P devices exchange device-related information such as a device name of a counterpart device or a device type with each other via an identical channel According to the service discovery, a service to be used and service-related information are exchanged with each other via P2P. According to the group formation, it corresponds to a function that a device to be a P2P GO is determined and a new group is formed. According to the P2P invitation, it corresponds to a function that a permanently formed P2P group is summoned or a function of making a P2P device join a legacy P2P group.

Secondly, P2P group operation explains P2P group formation and termination, connection to a P2P group, communication in a P2P group, a service for P2P client discovery, operation of a persistent P2P group and the like.

Thirdly, P2P power management is dealing with a method of managing power of a P2P device and a method of processing a signal on power saving mode timing.

Lastly, managed P2P device is dealing with a method of forming a P2P group in a single P2P device and a method of accessing an infrastructure network via a WLAN AP at the same time.

Characteristics of a P2P group are explained in the following. A P2P group is similar to a legacy infrastructure BSS (basic service set) in that a P2P GO plays a role of an AP and a P2P client plays a role of an STA. Hence, software capable of performing a role of a GO and a role of a client should be mounted on a P2P device. The P2P device is distinguished by using a P2P device address such as a MAC address. Yet, when the P2P device performs communication in a P2P group, the P2P device uses a P2P interface address. In this case, it is not necessary for the P2P device to use a single identifier (a globally unique ID) address. The P2P group includes a single identifier P2P group ID. The single identifier P2P group ID consists of a combination of an SSID (service set identifier) and a P2P device address. Wi-Fi P2P standard uses WPA2-PSK/AES for security. A life cycle of a P2P group has a temporary connection method and a persistent connection method for attempting an identical connection after prescribed time. In case of a persistent group, once a P2P group is formed, a role, a certificate, an SSID and a P2P group ID are cached. When connection is reestablished, connection of a group can be promptly established by applying an identical connection form.

In the following, Wi-Fi P2P connection method is explained. A Wi-Fi device mainly performs a connection procedure of two phases. First one corresponds to a phase that two P2P devices find out a counterpart device and a second one corresponds to a group formation phase for determining a role of a P2P GO or a role of a P2P client between discovered devices. First of all, the finding phase corresponds to a phase of connecting P2P devices with each other. In particular, the finding phase includes a search state and a listen state. The search state performs active search using a probe request frame. In this case, a range of the search is restricted for a quick search. For the quick search, such a social channel as a channel 1, 6 and 11 are used. A P2P device of the listen state maintains a reception state in a manner of selecting one channel from the 3 social channels. If the P2P device receives a probe request frame transmitted by a different P2P device of the search state, the P2P device transmits a probe response frame to the different P2P device in response to the probe request frame. P2P devices continuously repeat the search state and the listen state and may be able to arrive at a channel common to the P2P devices. The P2P devices find out a counterpart device and use a probe request frame and a probe response frame to selectively combine with the counterpart device and to discover a device type, a manufacturer, or a friendly device name. In order to check a service existing in the internal of the P2P devices and compatible between the devices, it may use the service discovery. The service discovery is used to determine whether a service provided in the internal of each device is compatible with a different device. According to the P2P standard, a specific service discovery standard is not designated. A user of a P2P device searches for a neighboring P2P device and a service provided by the P2P device and may be then able to connect with a device or a service preferred by the user.

As a second phase, a group formation phase is explained in the following. If a P2P device completes the aforementioned find phase, checking existence of a counterpart device is completed. Based on this, two P2P devices should enter a GO negotiation phase to configure a BSS. The negotiation phase is divided into two sub phases. One is a GO negotiation phase and another is a WPS (Wi-Fi protected setup) phase. In the GO negotiation phase, the two P2P devices negotiate a role of a P2P GO and a role of a P2P client with each other and an operation channel to be used in the internal of a P2P group is configured. In the WPS phase, such a usual job performed in a legacy WPS as exchanging PIN information inputted by a user using a keypad or the like, simple setup via a push button and the like is performed. In a P2P group, a P2P GO plays core role of the P2P group. The P2P GO assigns a P2P interface address, selects an operation channel of the group and transmits a beacon signal including various operation parameters of the group. In the P2P group, a beacon signal can be transmitted by the P2P GO only. A P2P device can quickly check the P2P GO using the beacon signal in a scan phase corresponding to a connection initial phase and performs a role of participating in the group. Or, the P2P GO can initiate a P2P group session by itself or may be able to initiate a session after the method mentioned earlier in the P2P finding phase is performed. Hence, since a value intended to be the P2P GO is controlled by an application or a higher layer service instead of a value fixed by a certain device, a developer can select an appropriate value, which is intended to be the P2P GO, according to a usage of each application program.

Subsequently, P2P addressing is explained in the following. A P2P device uses a P2P interface address in a manner of assigning a P2P interface address using a MAC address in a P2P group session. In this case, the P2P interface address of a P2P GO corresponds to a BSSID (BSS identifier). The BSSID practically corresponds to a MAC address of the P2P GO.

Connection release of a P2P group is explained in the following. If a P2P session is terminated, a P2P GO should inform all P2P clients of termination of a P2P group session via De-authentication. A P2P client can also inform the P2P GO of connection release. In this case, if possible, it is necessary to perform a disassociation procedure. Having received a connection release request of a client, the P2P GO can identify that connection of the P2P client is released. If the P2P GO detects a P2P client making a protocol error or performing an operation of interrupting connection of a P2P group, the P2P GO generates rejection of authentication or a denial of association. In this case, the P2P GO records a concrete failure reason on an association response and transmits the association response to the P2P client.

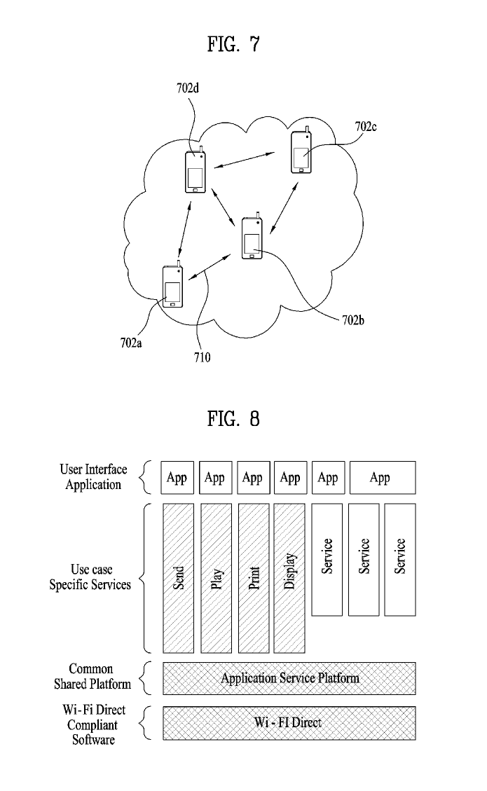

FIG. 7 is a diagram for a WFD network aspect in case that P2P is applied.

FIG. 7 shows an example of a WFD network aspect in case of applying a new P2P application (e.g., social chatting, location-based service provision, game interworking and the like). Referring to FIG. 7, a plurality of P2P devices 702a to 702d perform P2P communication 710 in a WFD network. P2P device(s) constructing the WFD network frequently change due to movement of the P2P device or the WFD network itself can be newly generated or disappeared dynamically/in a short time. Hence, characteristic of the new P2P application part is in that P2P communication can be performed and terminated dynamically/in a short time between a plurality of the P2P devices in dense network environment.

FIG. 8 is a simplified block diagram for a WFDS (Wi-Fi Direct services) device.

A platform for such an application service as an ASP (application service platform) is defined for a Wi-Fi Direct MAC layer and above. The ASP plays a role of session management, command processing of a service, control between ASPs and security between a higher application and a lower Wi-Fi Direct. 4 basic services including a Send service, a Play service, a Display service and a Print service defined by WFDS, a corresponding application and an UI (user interface) are supported at the top of the ASP. In this case, the Send service corresponds to a service capable of performing file transfer between two WFDS devices and an application therefor. The Play service corresponds to a streaming service capable of sharing A/V, a picture, and music based on a DLNA between two WFDS devices and an application therefor. The Print service defines a service capable of outputting a document and a picture between a device including contents such as a document, a picture and the like and a printer and an application therefor. The Display service defines a service enabling screen sharing between Miracast source of WFA and Miracast sink and an application therefor. And, an enablement service is defined for the use of an ASP common platform in case of supporting a third party application except a basic service.

Among terminologies described in the present invention, such a terminology as a service hash is formed from a service name using a first 6 octets of a service hash algorithm (e.g., SHA256 hashing) of a service name A service hash used by the present invention does not mean a specific service hash. Instead, it may be preferable to comprehend the service hash as a sufficient representation of a service name using a probe request/response discovery mechanism. As a simple example, if a service name corresponds to “org.wifi.example”, 6 bytes of a forepart of a value of which the service name is hashed by the SHA256 corresponds to a hash value.

In WFDS, if a hash value is included in a probe request message and a service is matched with each other, it may be able to check whether the service is supported in a manner of responding by a probe response message including a service name. In particular, the service name corresponds to a name of a user readable service of a DNS form. A service hash value indicates upper 6 bytes among a value of 256 bytes of the service name generated by an algorithm (e.g., SHA256). As mentioned in the foregoing example, if a service name corresponds to “org.wifi.example”, a service hash may correspond to a value of “4e-ce-7e-64-39-49”.

Hence, a part of a value of which a service name is hashed by an algorithm is represented as a service hash (information) in the present invention. The service hash can be included in a message as information.

Method of Configuring Legacy WFDS

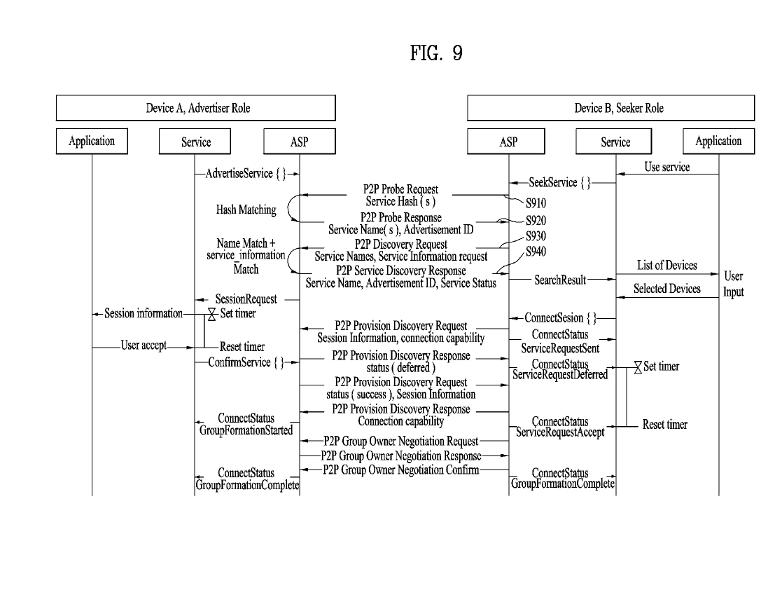

FIG. 9 is a flowchart for a process of establishing a WFDS session by discovering a device and a service between WFDS devices in a legacy WI-DS.

For clarity, as shown in FIG. 4, assume that a device A plays a role of an advertiser advertising a WFDS capable of being provided by the device A to a seeker and a device B plays a role in seeking an advertised service. The device A corresponds to a device intending to advertise a service of the device A and a counterpart device intends to start the service in a manner of finding out the service of the device A. The device B performs a procedure of finding out a device supporting a service according to a request of a higher application or a user.

A service end of the device A advertises a WFDS capable of being provided by the service end to an application service platform (ASP) end of the device A. A service end of the device B can also advertise a WFDS capable of being provided by the service end to an ASP end of the device B. In order for the device B to use a WI-DS as a seeker, an application end of the device B indicates a service to be used to the service end and the service end indicates the ASP end to find out a target device to use the WFDS.

In order to find out the target device to use the WI-DS, the ASP end of the device B transmits a P2P (peer to peer) probe request message [S910]. In this case, the P2P probe request message includes a service name, which is intended to be found out by the ASP end of the device B or is capable of being supported by the ASP end of the device B, in a service hash form in a manner of hashing the service name Having received the P2P probe request message from the seeker, if the device A supports the corresponding service, the device A transmits a P2P probe response message to the device B in response to the P2P probe request message [S920]. The P2P probe response message includes a service supported by a service name or a hash value and a corresponding advertise ID value. This procedure corresponds to a device discovery procedure indicating that the device A and the device B are WFDS devices. It is able to know whether a service is supported via the device discovery procedure.

Subsequently, it is able to know a specific service in detail via a P2P service discovery procedure, optionally. The device B, which has found a device capable of performing a WFDS with the device B, transmits a P2P service discovery request message to the device [S930]. Having received the P2P service discovery request message from the device B, the ASP end of the device A transmits a P2P service discovery response message to the device B in a manner of matching the service advertised by the service end of the device A with a P2P service name and a P2P service information received from the device B with each other [S940]. In this case, a GAS protocol defined by IEEE 802.11u is used. As mentioned in the foregoing description, when a request for a service search is completed, the device B can inform an application and a user of a search result. At this point, a group of Wi-Fi Direct is not formed yet. If a user selects a service and the selected service performs a connect session, P2P group formation is performed.

Before the present invention is explained, it is necessary to be cautious of one thing. It is necessary to distinguish a legacy Wi-Fi Direct connection from Wi-Fi Direct service (WFDS) connection described in the present invention. According to the legacy Wi-Fi Direct, it mainly concerns up to a L2 layer, whereas the recently discussed WFDS connection concerns not only the L2 layer but also a higher layer of the L2 layer. In particular, the WFDS connection is dealing with a service session connection performed by an application service platform. Hence, the WI-DS connection may have more diversified and more complex cases compared to the legacy L2 layer connection and it is required to have definition on the cases. In addition, in case of connecting Wi-Fi Direct only between devices and in case of connecting Wi-Fi Direct service between devices, configuration and order of a control frame, which is exchanged via Wi-Fi, may become different.

In this case, for example, among the aforementioned interfaces, the BLE may correspond to a Bluetooth transmission/reception scheme in a form of using a frequency of 2.4 GHz and reducing power consumption. In particular, in order to quickly transmit and receive data of extremely small capacity, it may use the BLE to transmit data while reducing power consumption.

And, for example, the NAN (neighbor awareness networking) network may correspond to NAN devices using a set of the same NAN parameters (e.g., a time period between continuous discovery windows, a period of a discovery window, a beacon interval, a NAN channel, etc.). The NAN devices can configure a NAN cluster. In this case, the NAN cluster uses a set of the same NAN parameters and may correspond to a set of NAN devices synchronized with the same window schedule. A NAN device belonging to the NAN cluster can directly transmit a multicast/unicast NAN service discovery frame to a different NAN device within a range of a discovery window.

And, for example, the NFC may operate on a relatively low frequency band such as 13.56 MHz. In this case, if two P2P devices support the NFC, it may optionally use an NFC channel A seeker P2P device can discover a P2P device using the NFC channel. When an NFC device is discovered, it may indicate that two P2P devices agree on a common channel for forming a group and share provisioning information such as a password of a device.

A method of interworking via an ASP for the aforementioned interfaces is explained in detail in the following. In this case, although the abovementioned configurations are proposed as an interface capable of being interlocked with the ASP, this is an example only. It may support a different interface as well, by which the present invention may be non-limited.

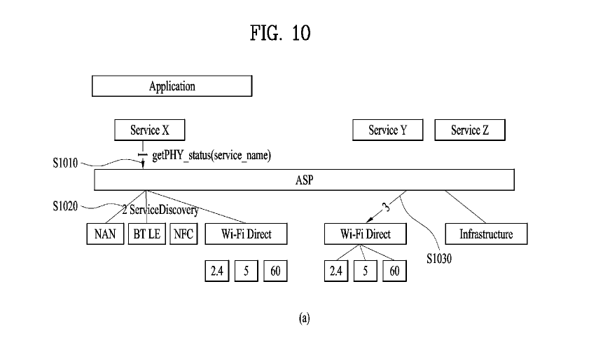

FIG. 10 illustrates an application service platform (ASP) supporting multiple interfaces.

As described above, a service end of an advertiser device as a device supporting WFDS may advertise a service that can be provided by the device, and a service end of a seeker device as another device supporting WFDS may instruct the ASP to seek a device which will use the service. That is, conventional systems can support WFDS between devices through the ASP.

Referring to FIG. 10, the ASP can support multiple interfaces. For example, the ASP can support multiple interfaces for performing service discovery. In addition, the ASP can support multiple interfaces for performing service connection.

For example, multiple interfaces which perform service discovery may be at least one of Wi-Fi Direct, NAN (Neighbor Awareness Networking), NFC (Near Field Communication), BLE (Bluetooth Low Energy) and WLAN Infrastructure.

In addition, the multiple interfaces which perform service discovery may be at least one of Wi-Fi Direct, P2P and infrastructure. For example, the ASP can support multiple frequency bands. Here, the multiple frequency bands may be 2.4 GHz, 5 GHz and 60 GHz, for example. In addition, the ASP can support information about frequency bands below 1 GHz. That is, the ASP can support multiple frequency bands and the frequency bands are not limited to specific frequency bands.

Referring to FIG. 10, a first device may perform device discovery or service discovery for a first service using the ASP. Then, when device discovery or service discovery has been sought, the first device may perform service connection on the basis of the seeking result. Here, an interface used to seek service discovery and an interface used for service connection may differ from each other and may be selected from the multiple interfaces.

In this case, information or parameters for supporting the above-mentioned interfaces may be used in the service application platform (ASP).

With respect to the aforementioned ASP, for example, a service end of a device may acquire information about a service discovery method and a service connection method capable of supporting a first service from the ASP. Here, the first service may be a service provided by the device and is not limited to a specific service.

The service end of the device may call an AdvertiseService( ) or SeekService( ) method from the ASP on the basis of the information acquired from the ASP. That is, the device can use the ASP as an advertiser or a seeker to perform service discovery for the first service, which may be the same as the conventional ASP operation. In addition, the device may perform service connection on the basis of the service discovery result after service discovery for the first service is performed. Here, service connection may be P2P connection or WLAN infrastructure connection. For example, both the service connections support multiple frequency bands and can be performed on the basis of a desired band.

More specifically, referring to FIG. 10a, the service end of the device may call getPHY_status(service_name) method and send a message about a service to be used to the ASP. Here, the service end may receive a return value from the ASP to acquire information on multiple frequency bands with respect to service discovery methods and service connection methods supported by the ASP. Accordingly, the device may notify the ASP of a preferred connection method and a preferred frequency band for the service and acquire information about the service discovery methods and the service connection methods supported by the ASP. The ASP may perform service discovery on the basis of the information received from the service end to seek a specific device and connect the device such that the service can be used.

Here, getPHY_status(service_name) may include information as shown in Table 1, for example. Information shown in right parts of Table 1 is subordinate to information shown at the left of Table 1.

TABLE 1

| Connectivity | P2P | Multiband | 2.4, 5, 60 GHz | |
|---|---|---|---|---|
| methods | | information | | |
| | Infrastructure | BSSID | | |
| | information | Multiband | 2.4, 5, 60 GHz | Channel |
| | | information | | Index |
| | | | | per band |

| Service | NAN | | |
|---|---|---|---|
| Discovery | BTLE | | |
| methods | NFC | | |
| | Infrastructure | | |
| | P2P | Multiband | 2.4, 5, 60 GHz |
| | | information | |

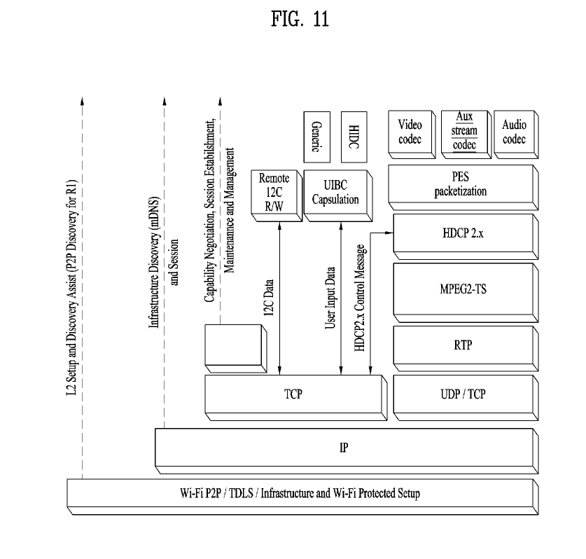

FIG. 11 is a structural view illustrating a data and control plane for use in a WFD terminal. Referring to FIG. 11, WFD terminals may perform connection using any one of Wi-Fi Direct (Wi-Fi P2P), Tunneled Direct Link Setup (TDLS), or Infrastructure. For example, WFD terminals for use in a conventional system may perform connection through any one of Wi-Fi Direct or TDLS. In contrast, WFD terminals for use in the present system may perform connection through any one of Wi-Fi Direct, TDLS or Infrastructure. For example, the WFD terminal may perform search and connection of the service on the basis of the above-mentioned ASP, without being limited thereto.

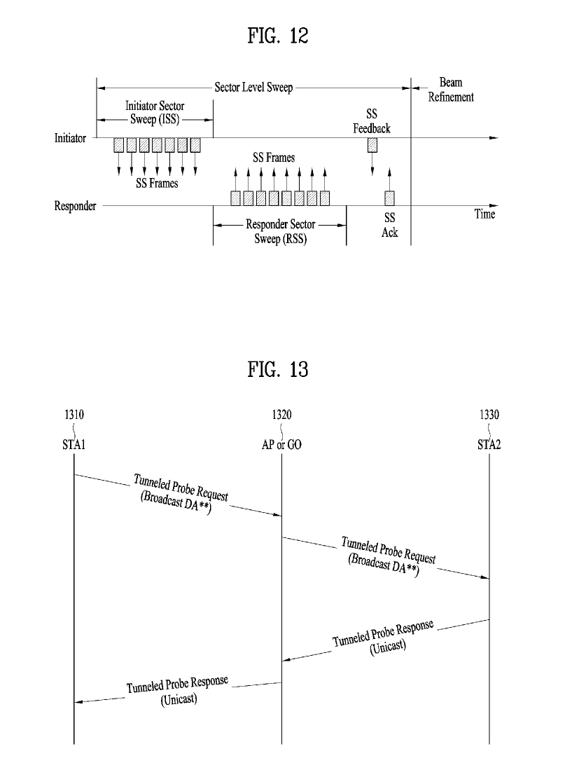

FIG. 12 is a conceptual diagram illustrating a beamforming training process applicable to the present invention. Basically, the beamforming procedure applicable to the present invention may be broadly classified into a Sector Level Sweep (SLS) phase and a BRP (Beam Refinement Protocol or Beam Refinement Phase) phase. In this case, the BRP process may be optionally carried out.

A terminal (or a station (STA) or a WFD terminal) scheduled to transmit data through beamforming will hereinafter be referred to as an initiator, and a terminal (or a station (STA) or WFD terminal) scheduled to receive data from the initiator may hereinafter be referred to as a responder.

In BF training encountered in Association BeamForming Training (A-BFT), an AP or PCP/AP may be an initiator, and a non-AP or non-PCP/AP STA may be a responder. In BF training generated in SP allocation, a source (EDMG) STA of the SP may be an initiator, and a destination STA of the SP may be a responder. In BF training within TXOP (Transmission Opportunity) allocation, a TXOP holder may be an initiator, and a TXOP responder may be a responder.

A link from the initiator to the responder may hereinafter be referred to as an initiator link, and a link from the responder to the initiator may hereinafter be referred to as a responder link.

In order to more reliably transmit data and control information in a 60 GHz band supported by an 11ay system applicable to the present invention, the directional transmission scheme instead of the omni-transmission method may be applied to the present invention.

As a process for the above operation, terminals to be used for data transmission/reception may recognize a TX or RX best sector for the initiator or the responder through the SLS phase.

BF training may be started with the SLS (Sector Level Sweep) from the initiator. The SLS phase may enable two terminals to communicate with each other in a control PHY rate or an upper MCS. Specifically, the SLS phase may provide transmission of only BF training.

In this case, the SLS is a protocol for performing link detection in an 802.11ay system applicable to the present invention. The SLS may be a beam training scheme for successively transmitting/receiving a frame having performance information of the Rx channel link while simultaneously allowing the network nodes to change only the beam direction, such that an index (e.g., SNR (Signal to Ratio), RSSI (Received Signal Strength Indicator), etc.) indicating the optimum frame from among the successfully received frames can select the best beam direction, as described above.

In addition, when a request from the initiator or the responder is present, the BRP (Beam Refinement Protocol or Beam Refinement Phase) may be arranged subsequent to the SLS.

An object of the RRP is to implement Rx training as well as to implement iterative refinement of Antenna Weight Vectors (AWVs) of all transmitters and receivers of all terminals. If one of STAs participating in beam training selects to use a Tx antenna pattern, Rx training may be carried out as a portion of the SLS phase.

In more detail, the SLS phase may include the following four elements. The SLS phase may include an Initiator Sector Sweep (ISS) for training the initiator link, a Responder Sector Sweep (RSS) for training the responder link, an SSW feedback, and an SSW ACK.

In this case, the initiator may start the SLS phase by transmitting ISS frame(s). The responder may not start transmission of RSS frame(s) prior to successful completion of ISS. However, the above-mentioned operation may be exceptionally used when ISS occurs in BTI. The initiator may not start SSW feedback before the RSS phase is not successfully completed. However, the above-mentioned operation may be exceptionally used when the RSS occurs in A-BFT. The responder may not start an SSW ACK of the initiator within the A-BFT. The responder may immediately start SSW ACK of the initiator after SSW feedback is successfully completed.

The BF frame transmitted from the initiator during the SLS phase may include (EDMG) beacon frame, SSW frame, and SSW feedback frame. The BF frame to be transmitted by the responder during the SLS phase may include an SSW frame and an SSW-ACK frame.

When each of the initiator and the responder performs TXSS (Transmit Sector Sweep) during the SLS phase, the initiator and the responder may possess their own Tx sectors at a time corresponding to the end of the SLS phase. If ISS or RSS employs a receive sector sweep (Rx sector sweep), the responder and the initiator may possess their own Rx sectors. The terminal may not change Tx power during the sector sweep.

In association with the WFD operation (e.g. Wi-Fi Display Release 1/Release 2/Release 3), a technology has been developed on the assumption that the WFD operation operates at 2.4 GHz or 5 GHz. However, as described above, the WFD terminal operation is defined at 60 GHz, and a technology based on the defined WFD terminal operation is not defined. Therefore, it is necessary to define the WFD terminal operation in consideration of 60 GHz frequency characteristics, and as such a detailed description thereof will hereinafter be given. For example, when 60 GHz frequency is applied to WFD technology, it is necessary to define a new procedure for establishing a link (Link Setup, Search and Connection Process) in a different way from the conventional art, and a detailed description thereof will hereinafter be given.

When Wi-Fi search and connection are performed on the basis of 60 GHz frequency, signal directivity of the 60 GHz beam may have linearity due to high-frequency characteristics as described above, resulting in occurrence of a directional beam. Therefore, when searching peripheral WFD terminals, instead of using the method for omnidirectionally transmitting the beacon only one time at 2.4 GHz or 5 GHz, the beacon needs to be transmitted several times for each sector such that the omnidirectional beacon transmission may be carried out. As a result, the WFD terminal may receive the beacon. That is, a transmitter may load the beacon on the directional beam while simultaneously changing the sector as described above, and may then transmit the resultant directional beam with the beacon. However, not only the transmitter but also the receiver may detect signals while simultaneously omnidirectionally sweeping the sector, and the receiver may receive the beacon and other messages from the transmitter. Therefore, because Wi-Fi search is performed on the basis of 60 GHz frequency, the amount of overhead may be larger than in the legacy art of 2.4 GHz or 5 GHz.

For example, when Line of Sight (LOS) is not guaranteed, SNR (Signal Noise Ratio) may be greatly deteriorated due to high-frequency characteristics. Therefore, the probability of packet loss may be rapidly increased as compared to the Wi-Fi network based on 2.4 GHz or 5 GHz.

Therefore, a new search and connection method of the WFD terminal based on the 60 GHz frequency in consideration of the above-mentioned situation will hereinafter be described.

### Embodiment 1

Considering the above-mentioned situation, 60 GHz WFD Direct Connection may be performed through the WLAN infrastructure channel using 2.4 GHz or 5 GHz.

More specifically, the WFD terminal may perform WFD search and connection using 2.4 GHz or 5 GHz frequency. In this case, the procedures after connection between the terminals supporting WFD may use 60 GHz frequency.

For example, in a “Wi-Fi Display (Miracast) over 60 GHz” operation procedure, the WFD terminal search and connection may be defined to operate on the basis of Wi-Fi infrastructure based on 2.4 GHz and 5 GHz frequencies.

For example, according to a topology in which the WFD terminal is connected to an Access Point (AP), WFD terminal search may be performed on the basis of legacy discovery mechanism, and a detailed description thereof is as follows. For example, the WFD terminal search may be carried out through the 802.11 data frame using Bonjour (Data Frame using Bonjour). In this case, the WFD terminals may be associated with the same BSS (or the same AP) using the same IP network, and thus the WFD terminals may search for 60 GHz-support WFD terminals using the mm/DNS-SD (mm/Domain Name System-Service Discovery) method over the same IP network. In this case, a seeker terminal for searching for the 60 GHz-support WFD terminal may include a service name shown in Table 2, such that the seeker terminal can transmit an mDNS query using a multicast or broadcast scheme. However, the above-mentioned service name is only an example, and may be written in different formats. However, the scope or spirit of the present invention is not limited thereto.

TABLE 2
- server name : “display_60ghz.tcp.local”

For example, the mDNS query transmitted from the seeker terminal may be transmitted to the terminals after passing through the AP (Multicast or Broadcast).

Neighbor WFD terminals supporting 60 GHz within a BSS having received the mDNS query may transmit the mDNS response to neighbor WFD terminals supporting 60 GHz after passing through the AP using the unicast scheme. In this case, the terminal having transmitted the mDNS response may be an advertiser terminal. The terminal having received the mDNS response may be the above-mentioned seeker terminal. For example, the mDNS query/response may be transmitted according to the IEEE 802.11 Data Frame Format.

In another example, the WFD terminal may perform search through the 802.11 data frame (802.11 Data Frame using UPnP) using UPnP. In this case, the WFD terminal may search for the 60 GHz-support WFD terminal using Simple Service Discovery Protocol (SSDP). In this case, the 802.11 data frame transmitted using the UPnP protocol may include information as to whether the WFD terminal has capability capable of supporting 60 GHz and UE information as to whether WFD is supported, and may then transmit the resultant information. In this case, the 802.11 data frame transmitted using the above-mentioned UPnP protocol may also be transmitted to neighbor terminals through the associated AP.

In another example, the WFD terminal may search for neighbor WFD terminals supporting 60 GHz through exchange between a TDLS probe request and a TDLS probe response. In this case, when searching for the 60 GHz-support WFD terminal, the WFD terminal may add 60 GHz capability information to WFD IE (Information Element) contained in the probe request frame and the probe response frame, and may then transmit the resultant WFD IE having 60 GHz capability information.

More specifically, referring to FIG. 13, WFD terminal 1 (or STA1) 1310 may transmit the TDLS probe request frame to the AP (or Group Owner (GO)) 1320. Thereafter, the AP may transmit the TDLS probe request frame using the broadcast or multicast scheme. As a result, WFD terminal 2 (or STA 2) 1330 may receive the TDLS probe request frame. In this case, the TDLS probe request frame may include specific information as to whether the WFD terminal 1 (1310) can support 60 GHz. For example, the capability information as to whether 60 GHz can be supported may be contained in the IE, as described above.

Thereafter, the WFD terminal 2 (1330) may transmit the TDLS probe response frame to the AP 1320. In this case, the TDLS probe response frame may include capability information as to whether the WFD terminal 2 (1330) can support 60 GHz. The TDLS probe response frame may be transmitted to the AP 1320 using the unicast scheme. The AP 1320 may transmit the TDLS probe response frame to the WFD terminal 1 (1310) using the unicast scheme. However, the scope or spirit of the present invention is not limited thereto.

As a result, the WFD terminal 1 (1310) and the WFD terminal 2 (1330) may provide the WFD service using 60 GHz frequency. For example, the 60 GHz support capability information may be designated by 1 bit. For example, when using the first value (e.g., ‘0’), the absence of 60 GHz support capability may be designated. In another example, when using the second value (e.g., ‘1’), the presence of 60 GHz support capability may be designated.

For example, the 60 GHz support capability information may be contained in at least one of WFD Capability IE and P2P Capability IE. In this case, at least one of the WFD Capability IE and the P2P Capability IE may be contained in the probe request frame, the probe response frame, and the beacon frame, as described above.

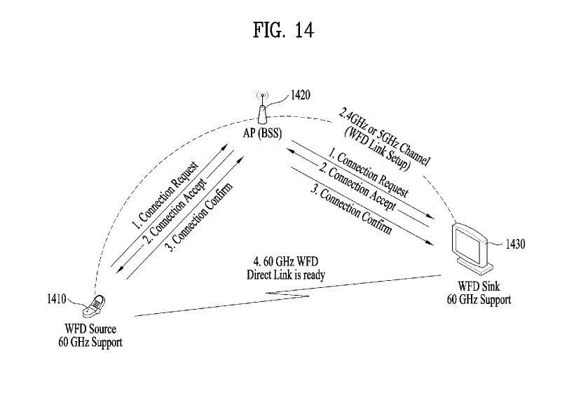

In another example, as shown in FIG. 14, the WFD terminals (1410, 1430) may request the link setup message through a 2.4 GHz or 5 GHz channel, may accept the requested link setup message, and may search the WFD direct link. In this case, the WFD source terminal 1410 may transmit the connection request message to the WFD sink terminal 1430 through the AP 1420. Thereafter, the WFD sink terminal 1430 may transmit the connection accept message to the WFD source terminal 1420 through the AP 1420. Thereafter, the WFD source terminal 1410 may transmit the connection confirmation message to the WFD sink terminal 1430 through the AP 1420, such that the WFD direct link may be established.

For example, the WFD source terminal 1410 and the WFD sink terminal 1430 may finish the 60 GHz direct link setup after completion of the above-mentioned steps. After link setup completion, packet exchange for RTP (Real Time Protocol) packet transmission among WFD capability negotiation, WFD session establishment, and WFD session may be achieved through the 60 GHz channel between the WFD source terminal 1410 and the WFD sink terminal 1430, such that information may be exchanged between the WFD source terminal 1410 and the WFD sink terminal 1430.

For example, the above-mentioned connection request message may be similar in format to the TDLS setup request frame defined in 802.11z. That is, format and information about the frame contained in the TDLS setup request frame may also be contained in the above-mentioned connection request message.

In addition, the connection accept message may be similar in format to the TDLS setup response frame defined in 802.11z. That is, format and information about the TDLS setup response frame may also be contained in the connection request message.

For example, the connection confirm message may be similar in format to the TDLS setup confirm frame defined in 802.11z. That is, format and information about the TDLS setup response frame may also be contained in the connection confirm message.

Through the above-mentioned steps, WFD terminals may perform 60 GHz connection through a 2.4 GHz or 5 GHz channel.

### Embodiment 2

As described above, it is necessary for each terminal to adjust the beam direction through sector sweep so as to exchange packets between the WFD source terminal and the WFD sink terminal on the basis of 60 GHz high-frequency characteristics. In this case, for example, the above-mentioned WFD terminals may transmit helpful information in advance through the WLAN infrastructure channel such that packet exchange can be smoothly achieved between the WFD terminals over the 60 GHz channel.

For example, the beacon transmission interval contained in the beacon frame of the legacy 802.11ad and the terminals' scheduling information transmitted from the AP may be provided in advance through the WLAN infrastructure channel. In this case, the scheduling information may be time information through which the AP-associated terminal can perform 60 GHz transmission. That is, information needed for the terminals operating at 60 GHz may be exchanged in advance through the WLAN infrastructure. For example, 60 GHz support terminals may perform direct communication in AP-associated status, as described above. That is, 60 GHz terminals may perform 60 GHz Concurrent Operation (WLAN Infrastructure mode, Wi-Fi Direct Mode).

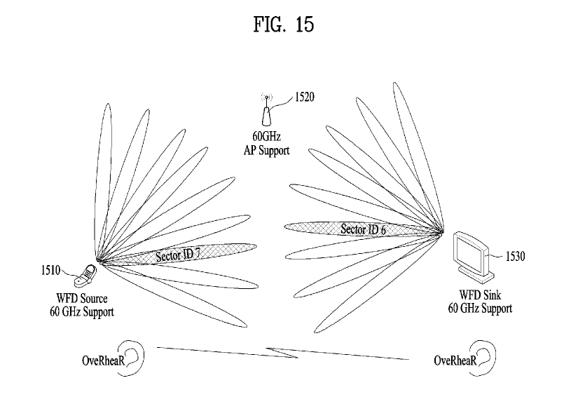

For example, referring to FIG. 15, each 60 GHz support terminal (i.e., WFD source 1510 and WFD sink 1530) may perform Sector Level Sweep (SLS) along with the 60 GHz AP 1520. In this case, the respective terminals may perform overhearing through the SLS process of the counterpart terminal.

More specifically, as shown in FIG. 15, the WFD sink terminal 1530 may receive packets transmitted when the WFD source terminal 1510 and the 60 GHz AP 1520 perform SLS. In this case, from the viewpoint of the WFD source 1510, when the WFD sink 1530 transmits 60 GHz packets by forming the beam using a sector ID 6 (Sector ID 6), the WFD source 1510 can receive the packets under the best conditions. In addition, from the viewpoint of the WFD sink 1530, when the WFD source 1510 transmits 60 GHz packets by forming the beam using a sector ID 7 (Sector ID 7), the WFD source 1510 can receive the packets under the best conditions.

Therefore, when the 60 GHz support terminals (1510, 1530) perform direct connection, the 60 GHz support terminals (1510, 1530) may omit the SLS phase.

More specifically, as shown in FIG. 15, when the WFD source terminal 1510 and the WFD sink terminal 1530 are associated with the 60 GHz support AP 1520, overhearing of the operation indicating that the WFD source terminal 1510 and the WFD sink terminal 1530 respectively perform AP and SLS may be performed. That is, the WFD sink terminal 1530 may acquire information about the sector of the WFD source terminal 1510 on the basis of the SLS procedure executed by the WFD source terminal 1510 and the AP 1520. In addition, the WFD source terminal 1510 may also acquire information about the sector of the WFD sink terminal 1530 on the basis of the SLS procedure executed by the WFD sink terminal 1530 and the AP 1520.

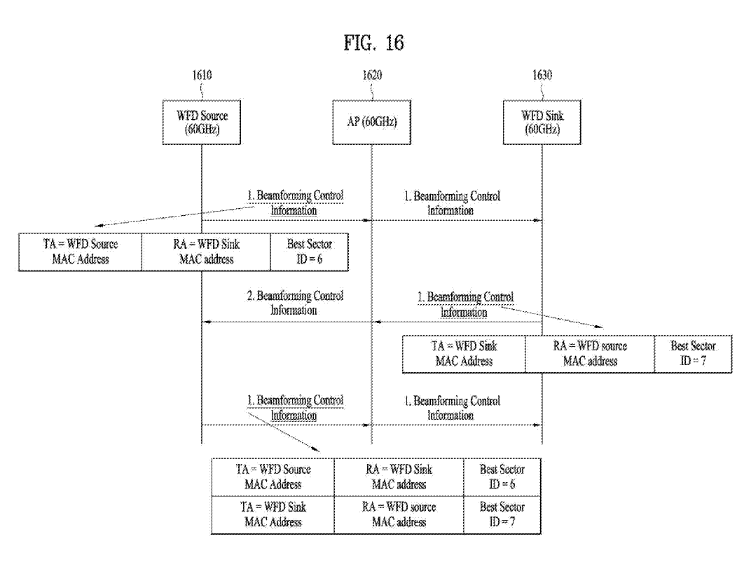

For example, 60 GHz support terminals (1510, 1530) may transmit overheard beamforming control information through the WLAN infrastructure interface, as shown in FIG. 16.

Referring to FIG. 16, the terminals having overheard the SLS process may transmit overheard beamforming control information to the counterpart terminals through the WLAN infrastructure interface as described above. In this case, the beamforming control information acquired through overhearing may be contained in the connection request message, the connection accept message, and the connection confirm message, and may then be transmitted.

More particularly, the connection request message may be shown in Table 3. In this case, the connection request message may be similar in format to the TDLS setup request frame defined in 802.11z. That is, the connection request message may be identical to the TDLS setup request frame in terms of format and information. For example, the above-mentioned beamforming control information may be further contained in the TDLS setup request frame, as shown in the following Table 3.

Referring to Table 3, the connection request message may include address information of a transmission (Tx) terminal and address information of a reception (Tx) terminal, as shown in the following Table 3. For example, the connection request message may include BS ID information as beamforming control information. In this case, BS ID information may include best sector ID information of the Rx terminal from the viewpoint of the Tx terminal, and the resultant BS ID information may then be transmitted. For example, as shown in FIG. 15, the WFD source terminal may perform overhearing of the WFD sink terminal and the AP's SLS process, and the sector ID 6 indicating the best sector ID of the WFD sink terminal may be contained in a BS ID, such that the WFD source terminal may transmit the resultant BS ID. As a result, when the Rx terminal transmits packets to the Tx terminal, the Rx terminal may form the beam using the sector ID corresponding to the BS ID, and may thus transmit packets using the resultant beam.

TABLE 3

| | | |
|---|---|---|
| Transmission Address | Reception Address | BS (Best Sector) ID |
| (Tx terminal's MAC | (Rx terminal's MAC | Best Sector ID (Best Sector ID) |
| Address) | Address) | of the Rx terminal from viewpoint |
| e.g: MAC address of | e.g: MAC address of WFD | of reception of the Tx terminal |
| WFD source terminal | sink terminal configured to | e.g: After the Tx terminal |
| configured to transmit | receive the connection | performs overhearing of the SLS |
| the connection request | request message | process of the Rx terminal, the |
| message | | Best Sector ID capable of being |
| | | received from the Rx terminal is |
| | | extracted and indicated. That is, |
| | | when packets are transmitted to |
| | | the Tx terminal, the Rx terminal |
| | | forms the beam using a sector ID |
| | | corresponding to BS ID, and then |
| | | transmits packets. |

In this case, as described above, the connection request message may be transmitted to the WFD sink terminal 1630 through the AP 1620. Thereafter, the WFD sink terminal 1630 may transmit the connection accept message to the WFD source terminal 1610 through the AP 1620. In this case, the connection accept message may be shown in the following Table 4. In this case, the connection accept message may be similar in format to the TDLS setup response frame defined in 802.11z. That is, the connection accept message shown in Table 4 may include the same format and information in the same manner as in the TDLS setup response frame. For example, the above-mentioned beamforming control information may be further contained in the TDLS setup response frame, as shown in the following Table 4. Referring to the following Table 4, the connection accept message may include address information of the Tx terminal and address information of the Rx terminal, as shown in the following Table 4. For example, the connection accept message may include BS ID information as beamforming control information. In this case, BS ID information may include best sector ID information of the Rx terminal from the viewpoint of the Tx terminal, and the resultant BS ID information may then be transmitted. For example, the WFD sink terminal shown in FIG. 15 may perform overhearing of the AP SLS process along with the WFD source terminal, and the sector ID 7 indicating the best sector ID of the WFD source terminal may be contained in the BS ID, such that the resultant BS ID may then be transmitted. As a result, when the Rx terminal transmits packets to the Tx terminal, the Rx terminal may form the beam using the sector ID corresponding to the BS ID, and may thus transmit packets using the resultant beam.

TABLE 4

| | | |
|---|---|---|
| Transmission Address | Reception Address | BS (Best Sector) ID |
| (Tx terminal's MAC | (Rx terminal's MAC | Best Sector ID (Best Sector ID) |
| Address) | Address) | of the Rx terminal from viewpoint |
| e.g: MAC address of | e.g: MAC address of WFD | of reception of the Tx terminal |
| WFD sink terminal | source terminal configured | e.g: After the Tx terminal |
| configured to transmit | to receive the connection | performs overhearing of the SLS |
| the connection accept | accept message | process of the Rx terminal, the |
| message | | Best Sector ID capable of being |
| | | received from the Rx terminal is |
| | | extracted and designated. That is, |
| | | when packets are transmitted to |
| | | the Tx terminal, the Rx terminal |
| | | forms the beam using a sector ID |
| | | corresponding to BS ID, and then |
| | | transmits packets. |

In this case, as described above, the connection confirm message may be transmitted to the WFD sink terminal 1630 through the AP 1620. In this case, the connection confirm message may be shown in the following Table 5. In this case, the connection confirm message may be similar in format to the TDLS setup confirm frame defined in 802.11z. That is, the connection confirm message shown in Table 5 may include the same format and information in the same manner as in the TDLS setup confirm frame. For example, the above-mentioned beamforming control information may be further contained in the TDLS setup response frame, as shown in the following Table 5. Referring to the following Table 5, beamforming control information contained in the connection confirm message may include not only beamforming control information transmitted from the terminal having transmitted the connection confirm message, but also the beamforming control information received through the connection accept message, and the resultant connection confirm message may then be transmitted. That is, beamforming control information contained in the connection request message and beamforming control information contained in the connection accept message may be included. For example, address information of the Tx terminal and address information of the Rx terminal may be included, as shown in the following Table 5. For example, the connection confirm message may include BS ID information as beamforming control information. In this case, the BS ID information may include BS ID information contained in the connection request message and the connection accept message. For example, BS ID information may include best sector ID information of the Rx terminal from the viewpoint of the Tx terminal, and the resultant BS ID information may then be transmitted. For example, the WFD source terminal shown in FIG. 15 may perform overhearing of the AP SLS process along with the WFD sink terminal, and the sector ID 6 indicating the best sector ID of the WFD sink terminal may be contained in the BS ID, such that the resultant BS ID may then be transmitted. As a result, when the Rx terminal transmits packets to the Tx terminal, the Rx terminal may form the beam using the sector ID corresponding to the BS ID, and may thus transmit packets using the resultant beam. In addition, BS ID information may further include the best sector ID information of the Rx terminal from the viewpoint of the Tx terminal, such that the resultant BS ID information may then be transmitted. For example, the WFD sink terminal shown in FIG. 15 may perform overhearing of the AL SLS process along with the WFD source terminal, the sector ID 7 indicating the best sector ID of the WFD source terminal may be contained in a BS ID, and the resultant BS ID may then be transmitted. As a result, when the Rx terminal transmits packets to the Tx terminal, the Rx terminal may form the beam using the sector ID corresponding to the BS ID, and may thus transmit packets using the resultant beam.

TABLE 5

| | | |
|---|---|---|
| Transmission Address | Reception Address | BS (Best Sector) ID |
| (MAC Address of Tx | (Rx terminal's MAC | Best Sector ID (Best Sector ID) of the |
| terminal) | Address) | Rx terminal from viewpoint of reception |
| e.g: MAC address of | e.g: MAC address of | of the Tx terminal |
| WFD source terminal | WFD sink terminal | e.g: After the Tx terminal performs |
| configured to transmit | configured to receive | overhearing of the SLS process of the Rx |
| the connection request | the connection request | terminal, the Best Sector ID capable of |
| message | message | being received from the Rx terminal is |
| | | extracted and designated. That is, when |
| | | packets are transmitted to the Tx terminal, |
| | | the Rx terminal forms the beam using a |
| | | sector ID corresponding to the BS ID, and |
| | | then transmits packets. |
| Transmission Address | Reception Address | BS (Best Sector) ID |
| (MAC Address of Tx | (Rx terminal's MAC | Best Sector ID (Best Sector ID) of the |
| terminal) | Address) | Rx terminal from viewpoint of reception |
| e.g: MAC address of | e.g: MAC address of | of the Tx terminal |
| WFD sink terminal | WFD source terminal | e.g: After the Tx terminal performs |
| configured to transmit | configured to receive | overhearing of the SLS process of the Rx |
| the connection accept | the connection accept | terminal, the Best Sector ID capable of |
| message | message | being received from the Rx terminal is |
| | | extracted and designated. That is, when |
| | | packets are transmitted to the Tx terminal, |
| | | the Rx terminal forms the beam using a |
| | | sector ID corresponding to the BS ID, and |
| | | then transmits packets |

60 GHz support terminals may implement 60 GHz direct connection through beamforming control information acquired through the connection request message, the connection accept message, and the connection confirm message. Thereafter, 60 GHz support terminals may perform exchange of RTSP (Real Time Steaming Protocol) messages for the WFD Capability Negotiation process without passing through the above SLS phase for searching for the optimal antenna configuration. However, the scope or spirit of the present invention is not limited thereto.

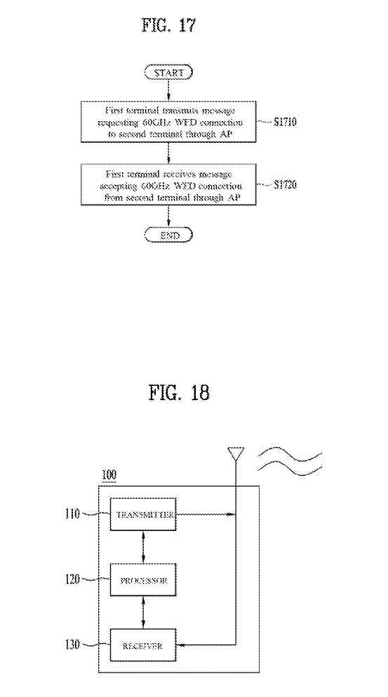

FIG. 17 is a flowchart illustrating a method for performing WFD connection.

Referring to FIG. 17, the first terminal may transmit a message requesting 60 GHz WFD connection to the second terminal through the AP (S1710). As previously illustrated in FIGS. 1 to 16, the first terminal and the second terminal may be WFD terminals. In this case, as described above, the sector may be changed through the beam having directivity at 60 GHz such that the optimal beam must be decided, resulting in increased overhead. Therefore, when WFD connection is performed through 60 GHz, WFD connection is performed through a 2.4 GHz or 5 GHz WLAN infrastructure channel, and the WFD service may then be transmitted at 60 GHz. For example, the WFD connection request message may include capability information as to whether the first terminal supports 60 GHz. That is, the WFD service can be provided at 60 GHz only when the terminal supports 60 GHz, such that the WFD connection request message may include associated information.

Subsequently, the first terminal may receive a message accepting 60 GHz WFD connection from the second terminal through the AP (S1720). As previously illustrated in FIGS. 1 to 16, the 60 GHz WFD connection accept message may include capability information as to whether the second terminal supports 60 GHz. Only when the terminal supports 60 GHz, it is possible to provide the WFD service at 60 GHz as described above, such that the 60 GHz WFD connection accept message may include associated information. For example, the first terminal may transmit a 60 GHz WFD connection confirm message to the second terminal through the AP.

For example, a message requesting 60 GHz WFD connection may include best sector ID information. In this case, the 60 GHz WFD connection request message may designate a sector by which the second terminal performs packet transmission on the basis of the best sector ID information. In this case, as described above, the second terminal may transmit information about the best sector of the second terminal to the AP on the basis of the SLS phase executed by the second terminal and the AP. In this case, the first terminal may perform overhearing of information transmitted from the second terminal. That is, the first terminal may receive information about the second terminal's best sector information transmitted to the AP.

In this case, the best sector may refer to one sector having the highest SNR or RSSI from among sectors that are established at 60 GHz by the second terminal. That is, the best sector may denote information indicating the optimum sector.

For example, a message accepting 60 GHz WFD connection may include the best sector ID information. As described above, the first terminal and the AP may perform the SLS phase. The first terminal may transmit the best sector information to the AP on the basis of the SLS phase. The second terminal may perform overhearing of specific information transmitted from the first terminal to the AP. That is, the second terminal may receive the first terminal's best sector information transmitted from the first terminal to the AP.

In this case, the sector at which the first terminal is scheduled to perform packet transmission may be instructed on the basis of the best sector ID information, as described above.

For example, a message confirming 60 GHz WFD connection may include best sector ID information. The 60 GHz WFD connection confirm message may include not only information about the sector where the first terminal performs packet transmission and information about the sector whether the second terminal performs packet transmission.

That is, when the first terminal and the second terminal perform 60 GHz WFD connection, the first terminal and the second terminal may omit the SLS phase, and may acquire associated information through the above-mentioned description. In contrast, when the first terminal and the second terminal directly perform 60 GHz WFD connection at 60 GHz, the first terminal and the second terminal may exchange the best sector ID information with each other on the basis of the SLS phase. However, the SLS phase may cause high overhead as described above, such that the SLS phase may be omitted and associated information can be acquired through message exchange as described above.

FIG. 15 is a block diagram of a device according to an embodiment of the present invention.

The terminal device may be a WFD support terminal. For example, the terminal may be a WFD source terminal or a WFD sink terminal.

Here, the device 100 may include a transmission module 110 which transmits radio signals, a reception module 130 which receives radio signals, and a processor 120 which controls the transmission module 110 and the reception module 130. The device 100 may perform communication with an external device using the transmission module 110 and the reception module 130. Here, the external device may be another device. For example, the external device may be another device connected through P2P, or an AP or a non-AP connected through WLAN infrastructure. Alternatively, the external device may be a base station. That is, the external device may be a device which can perform communication with the device 100 and is not limited to the above-described embodiments. The device 100 may transmit and receive digital data such as content using the transmission module 110 and the reception module 130.

According to an embodiment of the present invention, the processor 120 of the device 100 may establish an ASP session with a second device through a first connection method. Here, the processor 120 may transmit a session handover request to the second device using the transmission module 110. Then, the processor 120 may receive a session handover response from the second device using the reception module 130. Subsequently, the processor 120 may transmit Session Handover Confirm to the second device using the transmission module 110. Here, when the session handover response is received from the second device, the established ASP session may be handed over through a second connection method as described above.

The embodiments of the present invention may be achieved by various means, for example, hardware, firmware, software, or a combination thereof.

In a hardware configuration, the methods according to the embodiments of the present invention may be achieved by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, microcontrollers, microprocessors, etc.

In a firmware or software configuration, the embodiments of the present invention may be implemented in the form of a module, a procedure, a function, etc. Software code may be stored in a memory unit and executed by a processor. The memory unit may be located at the interior or exterior of the processor and may transmit data to and receive data from the processor via various known means.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

Both a product invention and a process invention are described in the specification and the description of both inventions may be supplementarily applied as needed.

As is apparent from the above description, the embodiments of the present invention can provide a WFD service on the basis of a frequency of 60 GHz in a wireless communication system.

The embodiment of the present invention can provide a method for performing WFD connection in consideration of 60 GHz frequency characteristics in a wireless communication system.

The embodiment of the present invention can provide a method for performing WFD connection at 60 GHz using 2.4 GHz or 5 GHz in a wireless communication system.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for performing 60 GHz WFD (Wi-Fi Display) connection by a first terminal in a wireless communication system, comprising:
transmitting, by the first terminal, a message requesting the 60 GHz WFD connection to a second terminal through an access point (AP); and
receiving a message accepting the 60 GHz WFD connection from the second terminal through the access point (AP),
wherein the 60 GHz WFD connection request message includes capability information indicating whether the first terminal supports 60 GHz,
the 60 GHz WFD connection accept message includes capability information indicating whether the second terminal supports 60 GHz, and
the messages are exchanged with each other on the basis of at least one of 2.4 GHz and 5 GHz.

2. The method according to claim 1, further comprising:
transmitting, by the first terminal, the message confirming the 60 GHz WFD connection to the second terminal through the access point (AP).

3. The method according to claim 2, wherein:
the message requesting the 6 GHz WFD connection includes best sector ID (identifier) information, and designates a sector by which the second terminal performs packet transmission on the basis the best sector ID information.

4. The method according to claim 3, wherein:
the second terminal transmits information about a best sector of the second terminal to the access point (AP) on the basis of a sector level sweep (SLS) phase performed not only by the second terminal but also by the access point (AP), and
the first terminal receives the second terminal's best sector information transmitted from the second terminal to the access point (AP).

5. The method according to claim 4, wherein the best sector information of the second terminal indicates a sector having the highest SNR (Signal to Noise Ratio) or the highest RSSI (Received Signal Strength Indicator) from among a plurality of sectors established by the second terminal at 60 GHz.

6. The method according to claim 2, wherein:
the message accepting the 6 GHz WFD connection includes best sector ID (identifier) information, and designates a sector by which the first terminal performs packet transmission on the basis the best sector ID information.

7. The method according to claim 2, wherein:
the message confirming the 6 GHz WFD connection includes best sector ID (identifier) information, and designates not only a sector by which the first terminal performs packet transmission, but also a sector by which the second terminal performs packet transmission based on the best sector ID information.

8. The method according to claim 1, wherein:
when the first terminal and the second terminal directly perform the 60 GHz WFD connection at 60 GHz, the first terminal exchanges best sector ID information with the second terminal on the basis of a Sector Level Sweep (SLS) phase.

9. The method according to claim 1, wherein:
the first terminal is a WFD source terminal, and the second terminal is a WFD sink terminal.

10. The method according to claim 1, wherein:
when packet transmission is performed at 2.4 GHz or 5 GHz, the packet is transmitted omnidirectionally; and
when packet transmission is performed at 60 GHz, the packet is transmitted in a specific direction.

11. A first terminal for performing 60 GHz WFD (Wi-Fi Display) connection in a wireless communication system, comprising:
a receiver configured to receive information from an external device;
a transmitter configured to transmit information to the external device; and
a processor configured to control the receiver and the transmitter,
wherein the processor transmits a message requesting the 60 GHz WFD connection to a second terminal through an access point (AP) using the transmitter, receives a message accepting the 60 GHz WFD connection from the second terminal through the access point (AP) using the receiver,
wherein the 60 GHz WFD connection request message includes capability information indicating whether the first terminal supports 60 GHz,
the 60 GHz WFD connection accept message includes capability information indicating whether the second terminal supports 60 GHz, and
the messages are exchanged with each other on the basis of at least one of 2.4 GHz and 5 GHz.

12. The first terminal according to claim 11, wherein the processor transmits the message confirming the 60 GHz WFD connection to the second terminal through the access point (AP) using the transmitter.

13. The first terminal according to claim 12, wherein:
the message requesting the 6 GHz WFD connection includes best sector ID (identifier) information, and designates a sector by which the second terminal performs packet transmission on the basis the best sector ID information.

14. The first terminal according to claim 13, wherein:
the second terminal transmits information about a best sector of the second terminal to the access point (AP) on the basis of a sector level sweep (SLS) phase performed not only by the second terminal but also by the access point (AP), and
the first terminal receives the second terminal's best sector information transmitted from the second terminal to the access point (AP).

15. The first terminal according to claim 14, wherein the best sector information of the second terminal indicates a sector having the highest SNR (Signal to Noise Ratio) or the highest RSSI (Received Signal Strength Indicator) from among a plurality of sectors established by the second terminal at 60 GHz.
